(19) United States
(12) Patent Application Publication
(10) Pub. No.: US 2009/0185657 A1
(43) Pub. Date: Jul. 23, 2009

(54) Registration method

(75) Inventor: Klaus Klingenbeck-Regn, Nurnberg (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 12/319,858

(22) Filed: Jan. 13, 2009

(30) Foreign Application Priority Data
Jan. 18, 2008 (DE) 10 2008 005 118.7

(51) Int. Cl. G01N 23/00

(52) U.S. Cl. 378/14

(57) ABSTRACT

The invention relates to a method for the geometric registration of an imaging device outside an object, in particular a radiation device, with a device emitting fan-shaped signals, in particular an ultrasound emitter, within the object, having the steps: recording a 3D image data record containing the device emitting fan-shaped signals using the imaging device outside the object; determining the position of the fan of the device emitting fan-shaped signals from the 3D image data record relative to the position of the imaging device outside the object; and determining a plane containing the fan as well as a line which is essentially perpendicular thereto, which connects the center point of the radiation source and the detector of the imaging device outside the object.

### CROSS REFERENCE TO RELATED APPLICATIONS

This application claims priority of German application No. 10 2008 005 118.7 filed Jan. 18, 2008, which is incorporated by reference herein in its entirety.

### FIELD OF THE INVENTION

The invention relates to a method for the geometric registration of an imaging device outside an object, in particular a radiation device, with a device emitting fan-shaped signals, in particular an ultrasound emitter, within the object.

### BACKGROUND OF THE INVENTION

Several imaging modalities are increasingly used consecutively in the case of interventional operations, in order to control the guidance of the interventional instruments. The aim here is to use the advantages of the respective modalities. One example of this is an intracardiac echocardiogram within electrophysiology, which is recorded in particular during ablations of atrial fibrillations. In this way, a registration of an intracardiac ultrasound emitter with an x-ray C-arm system arranged outside the patient is necessary. The acoustic waves used for imaging which have a fan-shaped form are characteristic here of the ultrasound emitter.

### SUMMARY OF THE INVENTION

The object of the invention is to specify a method for the geometric registration of these imaging devices.

To achieve this object, a method is provided which has the following steps:
recording a 3D image data record containing the device emitting fan-shaped signals using the imaging device outside the object,
determining the position of the fan of the device emitting fan-shaped signals from the 3D image data record relative to the position of the imaging device outside the object,
determining a plane containing the fan as well as a line which is essentially perpendicular thereto, which connects the center point of the radiation source and the detector of the imaging device outside the object.

A registration of the imaging device outside the object with the device emitting fan-shaped signals is thus possible, since the position of the emitter of the device emitting fan-shaped signals determines the spatial position of the fan. I.e. the position of the fan can be calculated from the position of the device. The position of the fan nevertheless determines the spatial position of the image data of the device. If one thus knows the relative position of the two imaging modalities in respect of each other, he/she also knows the relative position of the images generated thereby. The two imaging modalities are thus registered with one another after carrying out this method, since a mapping regulation can be determined, which connects and/or assigns to one another the two different coordinate systems of the two modalities and a superimposition and/or merging of the images generated thereby is easily possible. All additional changes of position can then be automatically detected by a computing device and included in a possible merging calculation.

The position determination of the fan of the device emitting fan-shaped signals in the 3D image data record can advantageously be performed automatically by a computing device, in particular by using at least one programming means. The automation of the position determination allows this to be performed in an extremely rapid and very precise fashion. The imaging unit in the 3D image data record is typically clearly silhouetted against the examined object and can thus be segmented with simple and rapidly operating algorithms. The position of the fan generated by this device can be inferred from the position of said device.

In the case of a 3D image-compatible device emitting fan-shaped signals, the center plane or a plane which is parallel to the center plane of the fan can preferably be used and the distance from the center plane can also be registered. The absolute position in the room is not important for the plane containing the fan, but instead its relative alignment compared with the imaging device outside the object. It is thus insignificant whether use is made of exactly the center plane or a plane which is parallel thereto; the line which is essentially perpendicular thereto and which connects the center point of the radiation source and the detector of the imaging device outside the object is always the same. Thus the plane which is most favorable for the plane calculations can be selected by the computing device.

Particularly advantageously, in the event of an interruption in the registration, the 3D image data record containing the device emitting fan-shaped signals can be recorded again, but with a smaller range which is essentially limited to the device. Such an interruption represents a movement for instance. This can be caused by the body of the patient moving or also merely by organ movements. In order to detect such an interruption in the registration, the device emitting fan-shaped signals can be equipped with a position detection device. Alternatively, two-dimensional x-ray images could also be recorded prior to and after the registration for this position detection and one possible displacement of the device could also be determined therefrom. The position of the device emitting the fan-shaped signals is approximately known after all from the already recorded 3D image data record which is unfortunately no longer completely suited to the registration process; said position can thus be used predominantly for the registration such that a smaller range is selected for imaging purposes. Doses can be reduced as a result and the acceptance by the patient on the one hand and the service life of the device on the other hand can thus be increased.

### BRIEF DESCRIPTION OF THE DRAWINGS

Further advantages, features and details of the invention result from the exemplary embodiments described below as well as with reference to the drawings, in which;

FIG. 1 shows a basic representation of an arrangement of two imaging modalities for implementing the method according to the invention,

FIG. 2 shows the geometric registration of the two imaging modalities according to the inventive method in a first embodiment, and

FIG. 3 shows the geometric registration of the two imaging modalities according to the inventive method in a second embodiment.

### DETAILED DESCRIPTION OF THE INVENTION

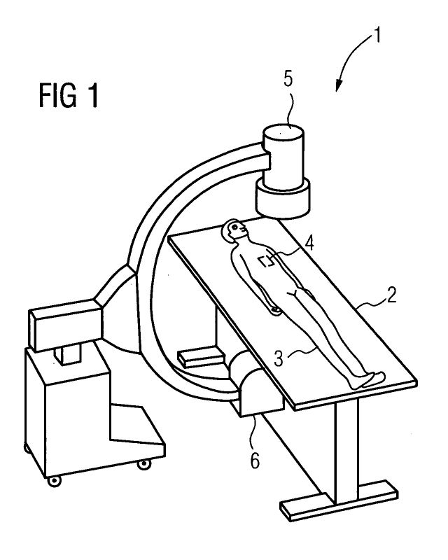

FIG. 1 shows a typical layout for performing an interventional operation. A patient 3 is positioned on a patient couch 2, whereby a minimally invasive heart valve replacement is to be performed. To control the guidance of the interventional instruments, in addition to a transesophageal echocardiogram (TEE), a fluoroscopy is also provided by means of an x-ray C-arm system 1. In order to obtain the TEE, an ultrasound emitter 4 has been inserted into the body of the patient.

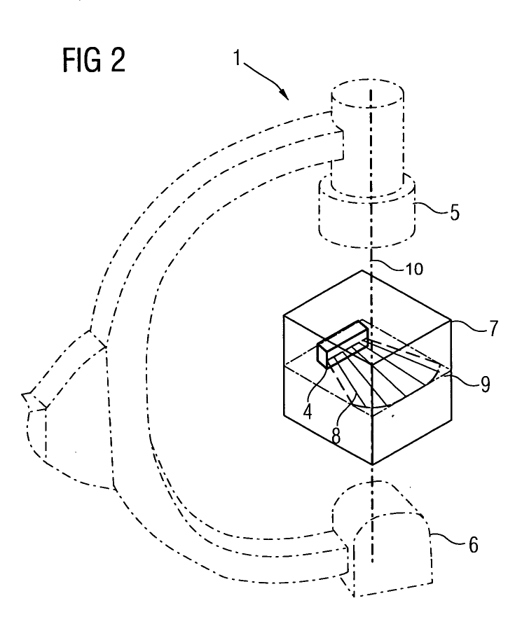

FIG. 2 shows how the geometric registration of the coordinate systems of the two imaging modalities is implemented. A 3D image 7 is recorded with the x-ray C-arm system 1. The ultrasound emitter 4 is included herein. The position and alignment of the ultrasound emitter 4 in the 3D image 7 can be determined by means of a simple segmentation algorithm. From this data, the radiation direction and the position of the fan 8 generated by the ultrasound emitter 8 is calculated. This fan 8 spans a plane 9, through which a line 10, which is perpendicular thereto, is calculated. For geometric registration, the line 10 is used [lacuna] the focus of the radiation source 5 and the center point of the detector 6 of the x-ray C-arm system 1 (central beam). This line 10 thus represents the central beam for an x-ray projection perpendicular to the fan plane 9. For the calculation of the line 10, use can also be made of the fact that it runs through the isocenter of the C-arm. As in this case the central beam of the x-ray C-arm system and the line 10 which is essentially perpendicular thereto are parallel to one another, the geometric registration is thus concluded. The ultrasound imaging and the x-ray imaging are now registered geometrically; the relative recording directions can be changed arbitrarily; a geometric assignment of the image data to one another is always possible.

In the event of the patient moving and a registration no longer being provided as a result, the method can be repeated, with it being possible to restrict the volume recorded by the 3D image data record 7 to the ultrasound emitter 4. A reduction in the exposure to dose is achieved as a result. Such an interruption in the registration is determined by a position detection system. The recording of two-dimensional x-ray images prior to and after the registration lends itself to this for instance. The position of the ultrasound emitter and a possible movement between the recordings can be detected from this.

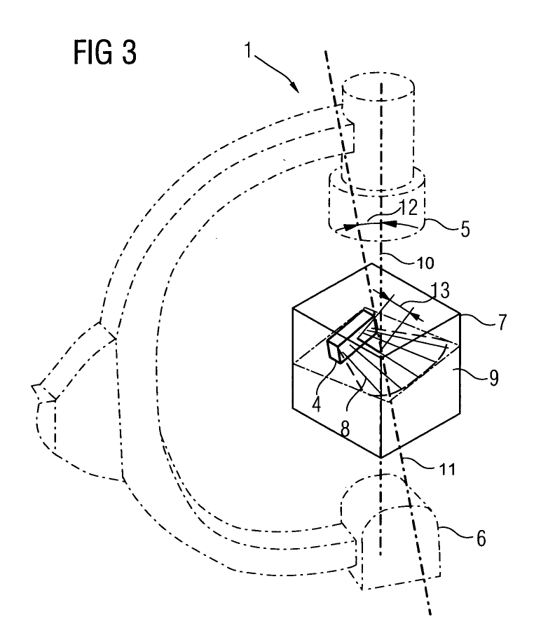

FIG. 3 shows the registration of the two imaging modalities, if these are tilted about an angle 12 to each other. The line 10 which is perpendicular to the plane 9 is tilted here about this angle 12 to the central beam 11 which connects the radiation source 5 to the detector 6. The distance 13 between the central beam 11 and the ultrasound emitter 4 is also known. All information is thus provided in order to register the two imaging modalities with one another.

1.-4. (canceled)

5. A method for geometrically registering an imaging device outside an object with a device emitting a fan-shaped signal within the object, comprising:
recording a 3D image data record containing the device emitting the fan-shaped signal by the imaging device outside the object;
determining a position of a fan containing the fan-shaped signal from the 3D image data record relative to a position of the imaging device outside the object; and
determining a plane containing the fan and a line that is essentially perpendicular to the plane and connects a center point of a radiation source and a detector of the imaging device outside the object.

6. The method as claimed in claim 5, wherein the position of the fan is determined automatically by a computing device.

7. The method as claimed in claim 5, wherein the plane comprises a center plane of the fan or a plane that is parallel to the center plane of the fan.

8. The method as claimed in claim 7, wherein a distance between the plane and the center plane is registered.

9. The method as claimed in claim 5, wherein the 3D image data record is recorded again with a smaller region that is essentially restricted to the device if the registration is interrupted.

10. The method as claimed in claim 5, wherein the imaging device outside the object is a radiation device.

11. The method as claimed in claim 5, wherein the device emitting the fan-shaped signal within the object is an ultrasound emitter.

12. A medical system, comprising:
a device within an object for emitting a fan-shaped signal within the object;
an imaging device outside the object for recording a 3D image data record containing the device emitting the fan-shaped signal; and
a processing device for geometrically registering the imaging device outside the object with the device within the object by:
determining a position of a fan containing the fan-shaped signal from the 3D image data record relative to a position of the imaging device outside the object, and
determining a plane containing the fan and a line that is essentially perpendicular to the plane and connects a center point of a radiation source and a detector of the imaging device outside the object.
